(19) United States
(12) Patent Application Publication
(10) Pub. No.: US 2009/0284796 A1
(43) Pub. Date: Nov. 19, 2009

(54) IMAGE FORMING APPARATUS, IMAGE FORMING METHOD AND RECORDING MEDIUM

(76) Inventor: Masaru USHIO, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/465,415

(22) Filed: May 13, 2009

(30) Foreign Application Priority Data
May 15, 2008 (JP) 2008-127931

(51) Int. Cl. G06K 15/02

(52) U.S. Cl. 358/1.18

(57) ABSTRACT

An image forming apparatus includes an image obtaining section to obtain a document image data including a text image data and a tab image data, an image forming section to form an image on a paper having a first side and a second side based on the document image data, an inverse conveyance section to inverse the paper in which the image based on the document image data is formed on the first side and re-convey the paper to the image forming section and a control section to carry out a control to divide the document image data into the text image data and the tab image data, and to form a tab image based on the tab image data on the second side of the paper which is inversed and conveyed at a position plane symmetrical to the tab image formed on the first side of the paper after a text image and the tab image are formed on the first side of the paper based on the document image data.

### BACKGROUND OF THE INVENTION

1. Field of the Invention

The present invention relates to an image forming apparatus, an image forming method and a recording medium.

2. Description of Related Art

Conventionally, there is an image forming apparatus which can carry out image forming on a tab paper. In the image forming apparatus, tab images such as an item, a title and the like can be formed at the tab portion. However, there is a problem relating to that the tab paper is a heavy paper and a problem that the paper is easily bent because of the existence of the tab portion, and image forming on both sides of the tab paper has been avoided.

In recent years, an image forming apparatus for carrying out image forming on both sides of the tab paper is being developed. As such image forming apparatus, an image forming apparatus which selects the paper feeding tray in which the tab paper is stored so that the tab portion is to be in orthogonal direction with respect to the conveyance direction when the mode for carrying out image forming on both sides of the tab paper is set is disclosed in JP2003-143367.

Further, according to JP2004-168034, a printing apparatus comprising a notification unit for notifying a message to a user when the process is determined as a process for carrying out image forming to a tab paper and when the image forming is carried out to the first side (for example, front side) of the tab paper, a detection unit for detecting a re-containing of the tab paper in which the image forming is carried out to the first side and an instruction receiving unit for receiving an instruction of the image forming to the second side (for example, back side) of the tab paper, wherein the image forming on the second side of the tab paper is executed according to the detection of the re-containment of the tab paper and according to the image forming instruction to the second side.

According to the technique of JP2003-143367, the problem of the paper bending when images are being formed on both sides of the tab paper is solved. However, the technique of JP2003-143367 cannot be applied to a case where a paper similar to the tab paper is to be generated by carrying out an after-processing to a predetermined standard size paper or in a case where the positions where the tab images are to be formed change in the front side and the back side.

Further, the technique of JP2004-168034 does not disclose details of image forming on back side for generating a standard size paper in which image forming is carried out to both sides as the tab paper. Furthermore, the technique of JP2004-168034 still requires intervention of operation by a user which causes complication.

### SUMMARY OF THE INVENTION

In view of the above problems, an object of the present invention is to provide a technique for generating a tab paper in which tab images are formed on both sides without troubling a user.

In order to achieve at least one of the above objects, an image forming apparatus reflecting an aspect of the present invention comprises an image obtaining section to obtain a document image data including a text image data and a tab image data, an image forming section to form an image on a paper having a first side and a second side which is a back side of the first side based on the document image data, an inverse conveyance section to inverse the paper in which the image based on the document image data is formed on the first side by the image forming section and re-convey the paper to the image forming section and a control section to carry out a control to divide the document image data into the text image data and the tab image data, and to form a tab image based on the tab image data on the second side of the paper which is inversed and conveyed by the inverse conveyance section at a position plane symmetrical to the tab image formed on the first side of the paper after a text image and the tab image are formed on the first side of the paper by the image forming section based on the document image data.

An image forming method reflecting an aspect of the present invention comprises image obtaining a document image data including a text image data and a tab image data, image forming an image on a paper having a first side and a second side which is a back side of the first side based on the document image data, inverse conveying the paper in which the image based on the document image data is formed on the first side by the image forming and re-convey the paper to the image forming and controlling to divide the document image data into the text image data and the tab image data, and to form a tab image based on the tab image data on the second side of the paper which is inversed and conveyed by the inverse conveying at a position plane symmetrical to the tab image formed on the first side of the paper after a text image and the tab image are formed on the first side by the image forming based on the document image data.

A recording medium reflecting an aspect of the present invention is a computer readable recording medium storing a program to make a computer realizes a function of a controller to carry out a control to divide a document image data including a text image data and a tab image data into the text image data and the tab image data, and to form a tab image based on the tab image data on a second side of a paper which is inversed and conveyed by an inverse conveyance section for inversing the paper in which an image based on the document image data is formed on a first side and re-conveying to an image forming section after forming a text image and the tab image based on the document image data by the image forming section for forming the image based on the document image data on the first side of the paper having the first side and the second side which is a back side of the first side.

### BRIEF DESCRIPTION OF THE DRAWINGS

The present invention will become more fully understood from the detailed description given hereinbelow and the appended drawings which are given by way of illustration only, and thus are not intended as a definition of the limits of the present invention, and wherein:

FIG. 1 is a schematic sectional structural diagram of an image forming apparatus;

FIG. 2 is a conceptual diagram showing an example of a copy setting screen;

FIG. 3 is a conceptual diagram showing an example of a document setting screen;

FIG. 4 is a conceptual diagram showing an example of a tab paper size setting screen;

FIG. 5 is a control block diagram of the image forming apparatus;

FIG. 6A is a conceptual diagram showing an example of a document;

FIG. 6B is a conceptual diagram showing an example of a document image data obtained from the document;

FIG. 7 is a diagram showing an example of a job data;

FIG. 8 is a flowchart showing a process to be executed at the start of copy;

FIG. 9 is a flowchart showing a process to be executed at the completion of reading of an image from the document;

FIG. 10 is a flowchart showing the first paper feeding preparation setting process;

FIG. 11 is a flowchart of a print page setting process;

FIG. 12 is a flowchart of a process to be executed when an image writing signal PVV is switched to OFF state from ON state;

FIG. 13 is a conceptual diagram of a both-side tab paper creating process executed in the embodiment; and

FIG. 14 is an example of a time chart of operation of the image forming apparatus 1 which realizes the both-side tab paper creating process of FIG. 13.

### DESCRIPTION OF THE PREFERRED EMBODIMENTS

Hereinafter, an embodiment of the present invention will be described in detail with reference to the drawings.

First, the structure will be described.

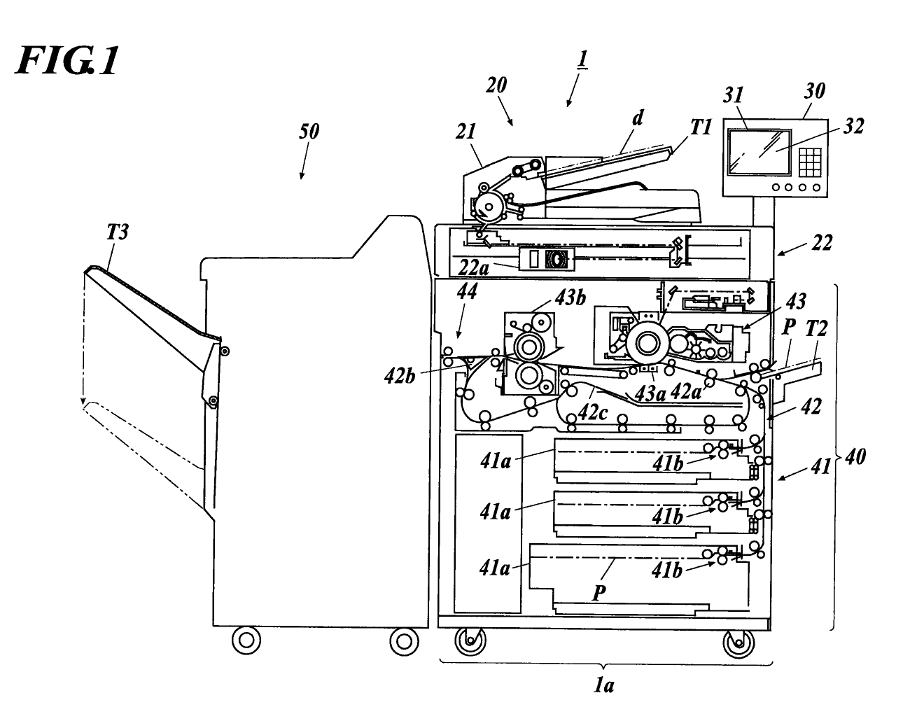

In FIG. 1, a schematic sectional structural diagram of the image forming apparatus 1 of the embodiment is shown.

The image forming apparatus 1 shown in FIG. 1 is an example of a digital multi function printer including a main body la and an after-processing section 50. The main body 1a comprises an image reading section 20, an operation display section 30, a print section 40 and the like. The main body la reads an image from a document, and forms the read image on a paper P and also forms an image based on image data received from an external device or the like on the paper P. The after-processing section 50 carries out the after-process to the paper in which the image is formed.

The image reading section 20 comprises an automatic document feeding section 21 called the ADF (Auto Document Feeder) and a reading section 22, and realizes a function of reading a plurality of document images based on setting information inputted from the operation display section 30. The document d placed on the document tray T1 of the automatic document feeding section 21 is conveyed onto the contact glass which is the reading position. Then, the image on one side or both sides of the document d is scanned by an optical system and the image of the document d is read by the CCD (Charge Coupled Device) 22a. Here, image is not limited to image data such as graphics, photographs and the like, and image includes text data such as letters, symbols and the like.

The image data (analog image signal) read by the image reading section 20 is outputted to the after-mentioned reading processing section 140 of the image control substrate and is outputted to the print section 40 after the A/D conversion and various types of image processes are carried out to the image data in the reading processing section 140.

The operation display section 30 comprises the LCD (Liquid Crystal Display) 31, the touch panel 32 provided so as to cover the LCD 31, operation keys (omitted from the drawing) and the like. The operation display section 30 receives instruction from a user and outputs the operation signal of the instruction to the control section 110. Further, the operation display section 30 displays various types of setting screen for inputting various types of operational instructions and setting information, various types of process results and the like according to the display signal which is inputted from the control section 110.

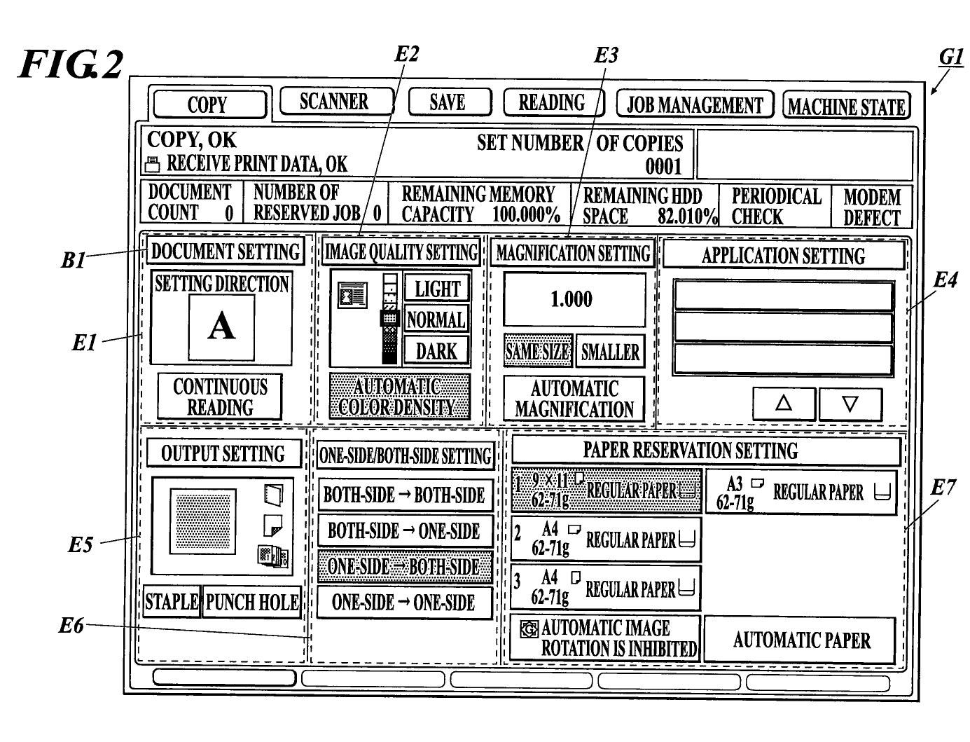

In FIGS. 2 to 4, examples of various types of setting screens to be displayed on the LCD 31 are shown. The various types of setting screens shown in FIGS. 2 to 4 are the screens for inputting and setting various types of setting conditions for the print process when the image forming apparatus 1 is made to execute the print process.

In FIG. 2, an example of the copy setting screen G1 is shown.

As shown in FIG. 2, the copy setting screen G1 comprises a document setting region E1, an image quality setting region E2, a magnification setting region E3, an application setting region E4, an output setting region E5, an one-side/both-side setting region E6 and a paper setting region E7, and the copy setting screen G1 is a screen for carrying out various types of settings of the image to be formed, various types of settings of paper on which the image is to be formed and the like.

In the document setting region E1, a document setting button B1 for displaying the document setting screen G2 is provided. In the image quality setting region E2, buttons for inputting instructions of density of the image to be formed on the paper are provided. In the magnification setting region E3, buttons for inputting instructions of magnification of the image to be formed on the paper are provided. In the output setting region E5, buttons for inputting instructions of after-processes of the paper on which the image is formed are provided. In the one-side/both-side setting region E6, buttons for inputting instructions (for example, one-side to both-side) of paper side in which the image of the image data of the read document is to be formed are provided. In the paper setting region E7, buttons which display the types of paper stored in each paper feeding tray and which are for inputting instructions of the paper tray from which the paper is to be fed are provided.

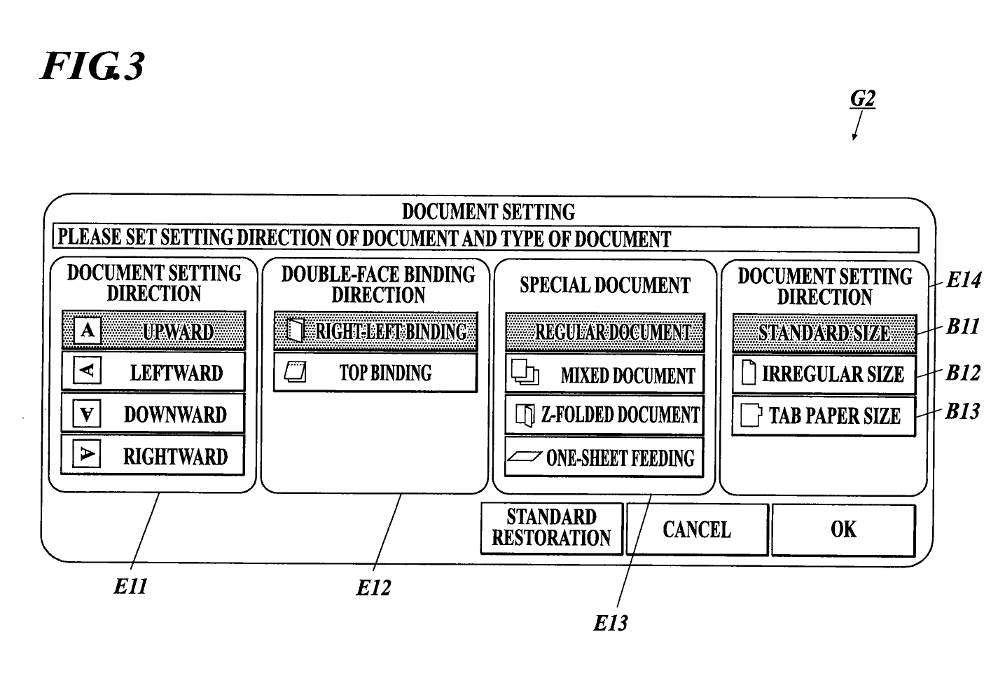

In FIG. 3, an example of the document setting screen G2 is shown.

As shown in FIG. 3, the document setting screen G2 comprises a document setting direction setting region E11, a binding direction setting region E12, a special document setting region E13 and a document size setting region E14, and the document setting screen G2 is a screen for carrying out various types of settings of the document in which the image is to be read by the image reading section 20.

In the document setting direction setting region E11, buttons for inputting instructions of setting direction of the document to be placed on the document tray T1 are provided. In the binding direction setting region E12, buttons for inputting instructions of binding direction of the document are provided. In the special document setting region E13, buttons for inputting instructions of type of the document (for example, a regular document in which size of all of the documents are the same, a mixed document which includes documents in different sizes, Z-folded document or the like) are provided. In the document size setting region E14, buttons for inputting instructions of type of the document size (standard size button B11, irregular size button B12 and tab paper size button B13) are provided. When the tab paper size button B13 is pushed, the tab paper size setting screen G3 is to be displayed.

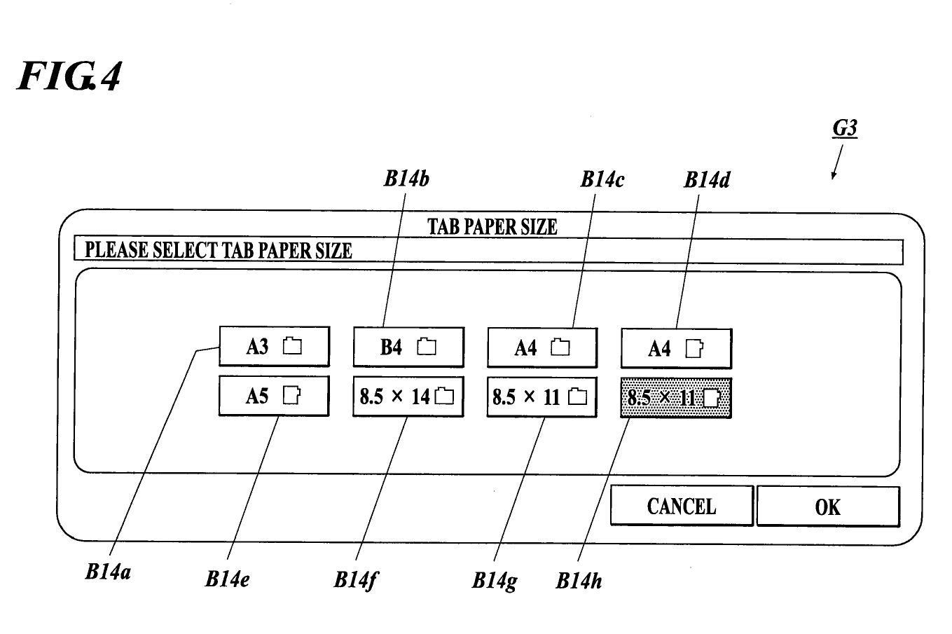

In FIG. 4, an example of the tab paper size setting screen G3 is shown.

As shown in FIG. 4, a plurality of buttons B14a to B14h for inputting instructions of size of the tab paper are provided in the tab paper size setting screen G3. For example, as for sizes of the tab paper, there are a horizontally long tab paper of A3 size, a horizontally long tab paper of B4 size, a horizontally long tab paper of A4 size, a vertically long tab paper of A4 size, a vertically long tab paper of B5 size, a horizontally long tab paper of 8.5 inch×14 inch size, a horizontally long tab paper of 8.5 inch×11 inch size and a vertically long tab paper of 8.5 inch×11 inch size.

The print section 40 carries out the electrophotographic image forming process based on the inputted print data, and the print section 40 comprises a paper feeding section 41, a paper conveyance section 42, an image forming section 43 and an ejecting section 44.

The paper feeding section 41 comprises a plurality of paper feeding trays 41a, paper feeders 41b, a manual tray T2 and the like. The papers P are housed in the paper feeding trays 41a, and the papers P are conveyed toward the paper conveyance section 42 by the paper feeders 41b one by one from the top. Various types of papers P can be placed and piled on the manual tray T2 according to the needs of a user, and the piled papers P are conveyed toward the paper conveyance section 42 by the paper feeding roller one by one from the top.

The paper conveyance section 42 conveys the paper P which is conveyed from the paper feeding tray 41a or the manual tray T2 to the transfer device 43a via a plurality of intermediate rollers, the resist roller 42a and the like.

Further, when the instruction of paper side on which the image of the image data of the read document is to be formed is the both-side mode which is from one-side to both-side, the paper conveyance section 42 functions as the inverse conveyance section which conveys the paper P in which the one-side image forming processing is already carried out to the both-side conveyance path 42c by the conveyance path switching board 42b and inverses the paper in which the one-side image forming is already carried out and which conveys the paper to the transfer device 43a via the intermediate rollers and the resist roller 42a again.

The image forming section 43 comprises a photoconductor drum, a charging device, the exposure device having the laser output section for outputting laser beam based on the image data and the polygon mirror for scanning the laser beam in the main scanning direction, the developing device, the transfer device 43a, the cleaning section and the fixing device 43b, and the image forming section 43 realizes a function of forming an image on the paper based on job information stored in the after-mentioned RAM 130. In particular, an electrostatic latent image is formed by the laser beam being irradiated by the exposure device to the photoconductor drum which is charged by the charging device. Then, the development device develops the electrostatic latent image by attaching toner which is charged on the surface of the photoconductor drum on which the electrostatic latent image is formed. The toner image formed by the development device on the photoconductor drum is transferred to the paper P in the transfer device 43a. Further, after the toner image is transferred to the paper P, the residual toner and the like on the surface of the photoconductor drum are removed by the cleaning section.

Moreover, the image forming section 43 realizes a function to form an image based on the document image data read by the image reading section 20 on the paper having the first side (for example, front side) and the second side (for example, back side) which is the back side of the first side.

The fixing device 43b heat fixes the toner image transferred to the paper P which is conveyed by the paper conveyance section 42. The paper P in which the fixing process is carried out is conveyed to the both-side conveyance path 42c by the conveyance path switching board 42b or is conveyed to the after-processing section 50 from the ejection outlet by being sandwiched by the paper ejection rollers of the ejecting section 44.

The after-processing section 50 comprises various types of after-processing units such as a sorting unit for carrying out a sorting process of the papers in which an image is formed, a punching unit for carrying out a punching process, a stapling unit for carrying out a stapling process to bind a bundle of papers according to the set binding direction and binding position, a folding unit for carrying out a folding process, a cutting unit for forming a tab portion by cutting a part of the paper and the like and a plurality of paper ejection trays T3 on which the papers after various types of processes are carried out or the papers in which various types of processes are not carried out are to be ejected and piled.

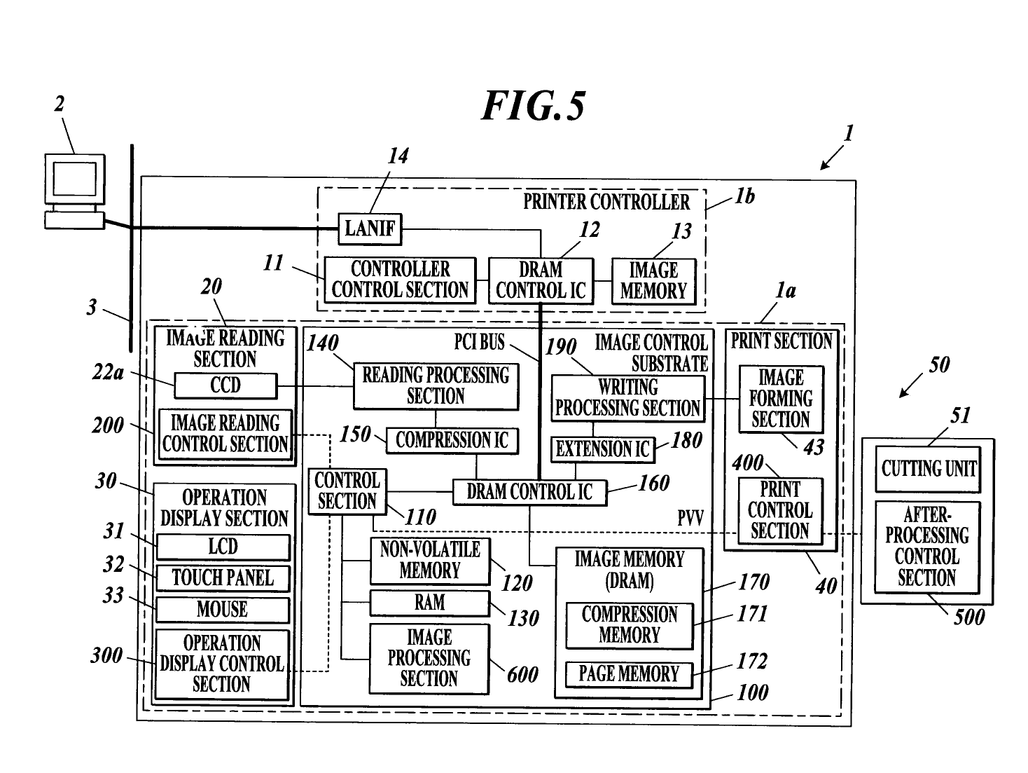

In FIG. 5, a control block diagram of the image forming apparatus 1 is shown.

As shown in FIG. 5, the image forming apparatus 1 comprises the main body 1a, the print controller 1b and the after-processing section 50 connected to the main body 1a. The image forming apparatus 1 is connected with the external device 2 on the network 3 via the LANIF (Local Area Network InterFace) 14 of the print controller 1b so as to send and receive information between each other.

The main body 1a comprises the image reading section 20, the operation display section 30, the print section 40 and the image control substrate 100. Here, the same symbols are used for the structural parts which are same as each part described in FIG. 1 and the descriptions are omitted.

The image control substrate 100 comprises the control section 110, the non-volatile memory 120, the RAM (RandomAccess Memory) 130, the reading processing section 140, the compression IC 150, the DRAM (Dynamic Random Access Memory) control IC 160, the image memory 170, the extension IC 180 and the writing processing section 190.

The control section 110 comprises the CPU (Central Processing Unit) and the like. The control section 110 reads the specified program and data among the system programs, various types of application programs and various types of data which are stored in the non-volatile memory 120 and expands the specified program and data in the RAM 130, and executes various types of processes in cooperation with the programs expanded in the RAM 130 to integrally control each part of the image forming apparatus 1. For example, the control section 110 carries out the control for switching between copy mode, printer mode and scanner mode, copying, printing, reading of image data and the like according to the instruction signal which is to be inputted from the operation display section 30 and the external device 2.

Further, the control section 110 transmits the image writing signal PVV to the print control section 400 of the print section 40. When the image writing signal PVV is in ON state, the toner image formed on the photoconductor drum is to be transferred to the paper P in the transfer device 43a, and when the image writing signal PVV is in OFF state, the toner image formed on the photoconductor drum will not be transferred to the paper P in the transfer device 43a.

Moreover, the control section 110 reads the both-side tab paper creating process program according to the embodiment from the non-volatile memory 120 and reads job data from the RAM 130, and the control section 110 divides the document image data which includes text image data and tab image data into the text image data and the tab image data in cooperation with the program and various types of data. Then, the control section 110 makes the image forming section 43 to form the text image and the tab image on the first side (front side) based on the document image data. Thereafter, the control section 110 carries out the control to form the tab image based on the tab image data at the position plane symmetrical to the tab image formed on the first side (front side) on the second side (back side) of the paper which is conveyed by the paper conveyance section 42 and which is inversed and conveyed by the conveyance path switching board 42b and the both-side conveyance path 42c. The control section 110 executes the control of creating a tab paper by making the cutting section cut the paper on which the image based on the tab image data is formed by the image forming section 43 on the second side to form the tab portion.

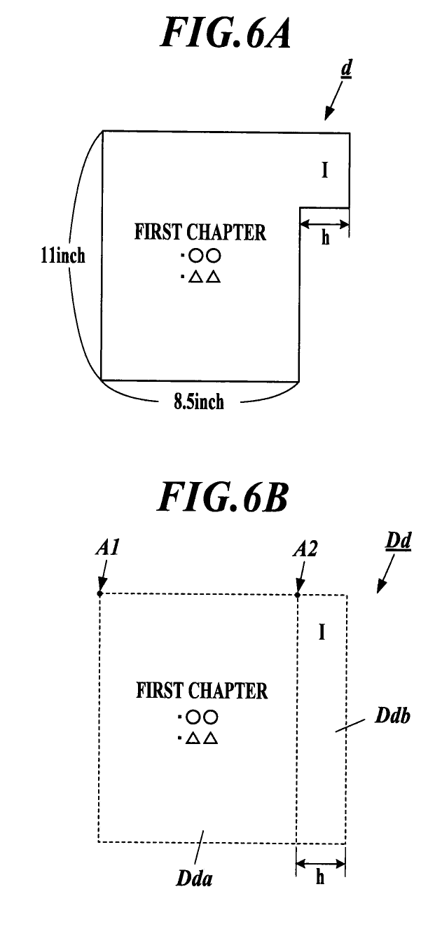

In FIG. 6A, an example of document d is shown, and in FIG. 6B, an example of document image data Dd obtained from the document d is shown.

When the control section 110 divides the document image data Dd into the text image data Dda and the tab image data Ddb, the control section 110 divides the document image data Dd according to the size (height h) of the tab portion in which the image based on the tab image data Ddb is to be formed. The height h of the tab portion can be calculated from the relation between the document size set by the document setting region E1 of the copy setting screen G1 and the paper size set by the paper setting region E7.

For example, when the document size is a vertically long tab paper of 8.5 inch×11 inch and when the paper size is a vertically long regular paper of 9 inch×11 inch, the difference of the widths (0.5 inch) of these papers is calculated as the height h of the tab portion. The document image data is divided in sub-scanning direction based on the height h of the tab portion to be divided into the text image data and the tab image data.

Further, when the control section 110 forms the image based on the tab image data Ddb on the second side by the image forming section 43, the control section 110 sets the image forming start position of the tab image data Ddb to the image forming start position of the text image data Dda which is formed on the first side.

For example, when forming the text image and the tab image based on the document image data Dd on the first side, the control section 110 sets the first address A1 of the document image data Dd stored in the page memory to the writing start position. When forming the image based on the tab image data Ddb on the second side, the control section 110 sets the start position A2 of the tab image data Ddb which divides the document image data Dd in sub-scanning direction according to the height h of the tab portion to the writing start position. By such setting of the writing start position, the image forming start position of the tab image data Ddb can be set to the image forming start position of the text image data Dda formed on the first side and the tab image based on the tab image data is to be formed in the second side at the position plane symmetrical to the tab image formed on the first side.

The non-volatile memory 120 stores the both-side tab paper creating process program according to the embodiment, data processes by various types of programs and the like other than various types of processing programs and data according to the image forming.

The RAM 130 forms a work area for temporarily storing various types of programs to be executed by the control section 110, data according to the programs, the job data and the like.

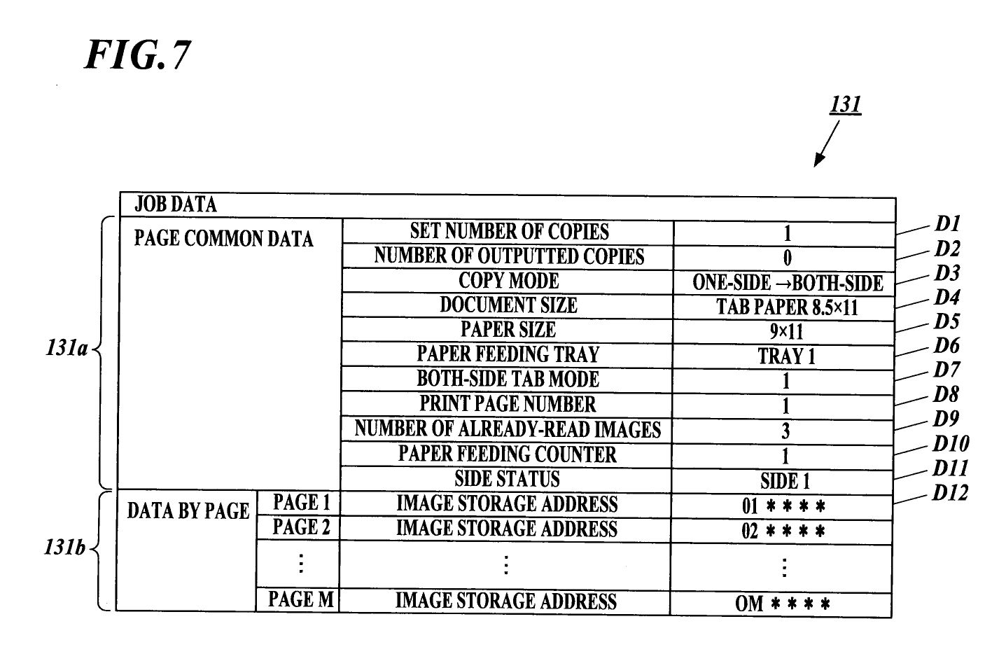

In FIG. 7, an example of job data is shown.

As shown in FIG. 7, the job data 131 comprises data common for each document page (page common data 131a) and data for each document page (data for each page 131b).

The page common data 131a includes data showing various types of setting conditions which are set based on the instruction signal inputted from the operation display section 30 and data showing the operation condition of the image forming operation and the after-processing operation.

For example, as for the page common data 131a, there are a set number of copies D1, a number of already outputted copies D2, the copy mode D3, the document size D4, the paper size D5, the paper feeding tray D6, the both-side tab mode D7, the print page number D8, the number of already read images D9, the paper feeding counter D10, the SIDE status D11 and the like.

The set number of copies D1 shows the number of outputted copies of the papers P.

The number of already outputted copies D2 shows the counted value of the number of copies which are already outputted.

The copy mode D3 shows the side on which the image data is to be formed, that is, one-side print to both-side print, both-side print to one side-print or the like.

The document size D4 shows the set document size. The paper size D5 shows the set paper size. The paper feeding tray D6 shows the tray in which set papers are stored.

The both-side tab mode D7 shows whether the mode for creating a tab paper in which the images are formed on both sides (the first side and the second side) of the paper is set or not. In the embodiment, when the mode is set to the mode of creating a tab paper in which the images are formed on both sides, “1” is set, and when the mode is not set to the mode of creating a tab paper in which the images are formed on both sides, “0” is set.

The print page number D8 shows the identification number of the individual image data corresponding to the document page in which the image forming process is to be carried out. The number of already read images D9 shows the total number of the read individual image data. The paper feeding counter D10 shows the number of papers fed from the paper feeding tray.

The SIDE status D11 shows the side of the paper in which the image is to be formed, and the first side (front side) is indicated as “side 1” and the second side (back side) is indicated as “side 2”.

As for the data for each page, the identification number (for example, page 1, page 2 . . . ) is assigned to the document image data corresponding to each of the read document page and the data for each page is stored individually. Each document image data is constituted with the image storage address D12 showing the address on the image memory 170 in which the document image data is stored and the like.

The reading processing section 140 carries out various types of processes such as the analog process, the A/D conversion process, the shading process and the like to the analog image signal which is inputted from the image reading control section 200 of the image reading section 20, and then, the reading processing section 140 generates the digital image data. The generated image data is outputted to the compression IC 150.

The compression IC 150 carries out the compression process to the inputted digital image data and outputs the compressed digital image data to the DRAM control IC 160.

The DRAM control IC 160 controls the compression process of the image data by the compression IC 150 and controls the extension process of the compressed image data by the extension IC 180 and controls the input and output of the image data to and from the image memory 170 according to the instruction from the control section 110.

For example, when it is instructed to save the image signal which is read by the image reading section 20, the compression process of the image data inputted from the reading processing section 140 is executed by the compression IC 150 and the compressed image data is stored in the compression memory 171 of the image memory 170. Further, when it is instructed to print output the compressed image data stored in the compression memory 171, the compressed image data is read from the compression memory 171 and the extension process is carried out to the compressed image data by the extension IC 180 to be stored in the page memory 172. Furthermore, when it is instructed to print output the image data stored in the page memory 172, the image data is read from the page memory 172 and is output to the writing processing section 190.

The image memory 170 comprises the compression memory 171 and the page memory 172 which are constituted with the DRAM (Dynamic RAM). The compression memory 171 is a memory for storing the compressed image data and the page memory 172 is a memory for temporarily storing the image data (print data) for print output.

The extension IC 180 carries out the extension process to the compressed image data.

The writing processing section 190 generates the print data for the image forming based on the image data inputted from the DRAM control IC 160 and outputs the print data to the print section 40.

The image reading section 20 comprises the CCD 22a and the image reading control section 200, and also comprises the automatic document feeding section 21 and the reading section 22 which are not shown here but are shown in FIG. 1 and the like. The image reading control section 200 controls the automatic document feeding section 21, the reading section 22 and the like and executes the exposure scanning of the document surface to read the image by carrying out the photoelectric conversion to the reflection light by the CCD 22a. The read analog image signal is outputted to the reading processing section 140.

The operation display section 30 is constituted with the LCD 31, the touch panel 32, the operation display control section 300 and also a group of operation keys such as ten keys and the like. The operation display control section 300 makes the LCD 31 display various types of screens for inputting various types of setting conditions, various types of setting screen as shown in FIGS. 2 to 4, various types of processing results and the like according to the display signal which in inputted by the control section 110. Further, the operation display control section 300 outputs the operation signals which are inputted from various types of switches and buttons, the ten keys, the group of operation keys and the touch panel 32 to the control section 110.

The print section 40 comprises each portion related to print output such as the image forming section 43 shown in FIG. 1 and the like and the print control section 400. The print control section 400 controls the operation of each portion of the print section 40 such as the image forming section 43 and the like according to the instruction from the control section 110 and makes the each portion of the print section 40 carry out the image forming on the paper P based on the print data inputted from the writing processing section 190. Further, the print control section 400 outputs the instruction signal for operating each portion of the after-processing section 50 to the after-processing control section 500 according to the instruction from the control section 110.

Various types of after-processing units such as the sorting unit, the punching unit, the stapling unit, the folding unit, the cutting unit 51 and the like, the conveyer such as the conveyance roller for conveying the paper to various types of after-processing units, the paper ejection tray T3 to which the paper which is conveyed from various types of after-processing units is ejected are provided at the after-processing section 50. The various types of after-processing units are integrally controlled by the after-processing control section 500. The after-processing control section 500 conveys the paper P to a predetermined after-processing unit along the conveyance path according to the instruction signal of the after-process inputted from the control section 110 via the print control section 400, and the after-processing control section 500 controls the drive of each portion to carry out the predetermined after-process to the paper P and controls so as to eject the paper to the paper ejection tray T3.

Next, each portion of the print controller 1b will be described. When the image forming apparatus 1 is used as the network printer, the printer controller 1b carries out management and control of the job which is to be inputted to the image forming apparatus 1 from the external device 2 connected to the network 3. The print controller 1b receives the data which is targeted for print from the external device 2 and transmits the data to the main body 1a as a job.

The printer controller 1b comprises the controller control section 11, the DRAM control IC 12, the image memory 13 and the LANIF 14.

The controller control section 11 integrally controls the operation of each portion of the printer controller 1b and transmits the data which is inputted from the external device 2 to the main body 1a via the LANIF 14 as a job.

The DRAM control IC 12 controls the storing of the data received by the LANIF 14 in the image memory 13 and the reading of the data from the image memory 13. Further, the DRAM control IC 12 is connected to the DRAM control IC 160 of the image control substrate 100 by the PCI (Peripheral Components Interconnect) bus, and the DRAM control IC 12 reads the data targeted for print from the image memory 13 and outputs to the DRAM control IC 160 according to the instruction from the controller control section 11.

The image memory 13 is constituted with the DRAM and temporarily stores the inputted output data.

The LANIF 14 is a communication interface for connecting with the network 3 which is the LAN or the like such as the NIC (Network Interface Card) or the modem, and the LANIF 14 receives data from the external device 2. The received data is outputted to the DRAM control IC 12.

Next, the operation of the embodiment will be described.

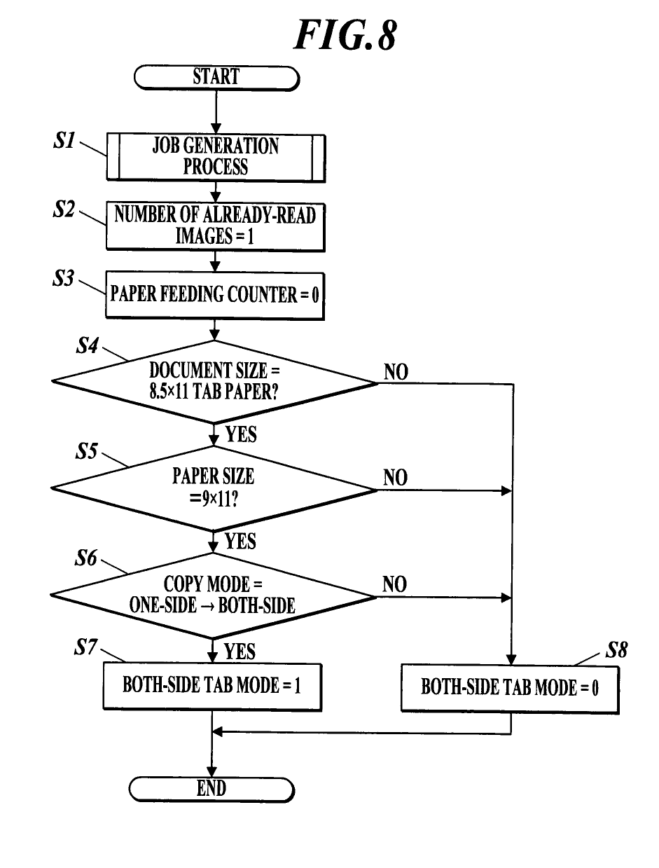

In FIGS. 8 to 12, flowcharts of the both-side tab paper creating process of the embodiment are shown. The flowcharts shown in FIGS. 8 to 12 are the processes which are executed by the control section 110.

The flowchart shown in FIG. 8 is the process which is to be executed at the start of copy.

First, when various types of setting conditions are inputted at the operation display section 30 and when a document is placed on the document tray T1, the control section 110 generates as job data with the inputted various types of setting conditions (for example, set number of copies, copy mode, document size, paper size, paper feeding tray and the like) and stores the job data in the RAM 130 (step S1).

Further, the control section 110 sets the number of already read images D9 of the job data which is generated in step S1 to 1 (step S2), and the control section 110 sets the paper feeding counter D10 to 0 (step S3).

The control section 110 refers to the job data generated in step S1 to determine whether the document size is a tab paper of 8.5 inch×11 inch or not (step S4). When the document size is a tab paper of 8.5 inch×11 inch (step S4; Yes), the control section 110 determines whether the paper size is 9 inch×11 inch or not (step S5).

When the paper size is 9 inch×11 inch (step S5; Yes), the control section 110 determines whether the copy mode is the mode of one-side to both-side print or not (step S6).

When the copy mode is the mode of one-side to both-side print (step S6; Yes), the control section 110 sets the both-side tab mode D7 to 1 (step S7) and finishes the process.

When either one of the setting conditions where the document size is not a tab paper of 8.5 inch×11 inch (step S4; No), where the paper size is not 9 inch×11 inch paper (step S5; No) or where the copy mode is not the mode of one-side to both-side print (step S6; No) applies, the control section 110 sets the both-side tab mode to 0 (step S8) and finishes the process.

That is, in the embodiment, the condition for setting the both-side tab mode D7 to 1 is when the document size is a tab paper of 8.5 inch×11 inch, when the paper size is 9 inch×11 inch paper and when the copy mode is the both-side mode of one-side to both-side print.

Here, as long as the relation between the document size and the paper size is a relation where the length in sub-scanning direction of the document is smaller than the length in sub-scanning direction of the paper to be fed for the height of the tab portion to be formed in the cutting section (for example, 0.5 inch), sizes of document and paper are not limited to the above sizes.

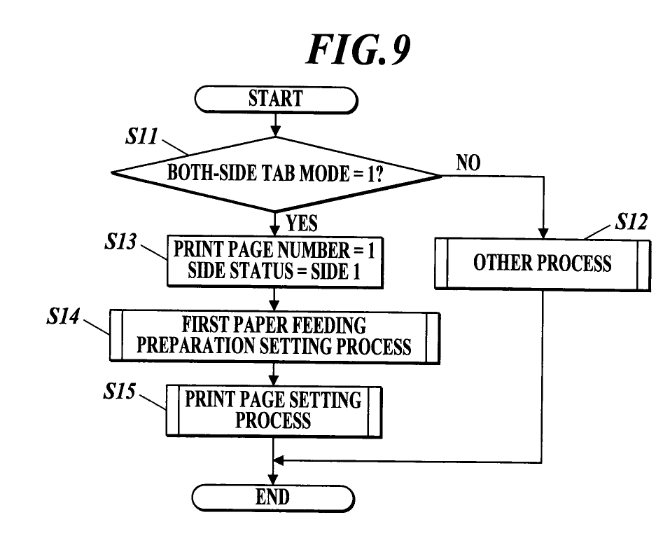

The flowchart shown in FIG. 9 is the process which is executed at the time of completion of reading of the image from the document d.

The control section 110 stores each of the document image data read by the image reading section 20 in the RAM 130 as job data, and also the control section 110 refers to the job data to determine whether the both-side tab mode D7 is set to 1 or not (step S11). When the both-side tab mode D7 is not set to 1 (step S11; No), the control section 110 executes other processes (step S12) and finishes the process.

When the both-side tab mode D7 is set to 1 (step S11; Yes), the control section 110 sets the print page number D8 to 1 and sets the SIDE status D11 to side 1 (step S13).

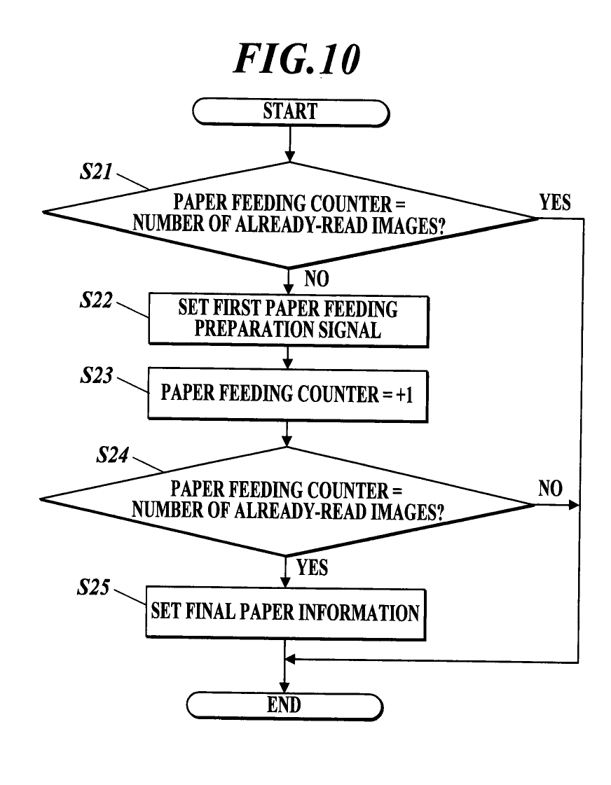

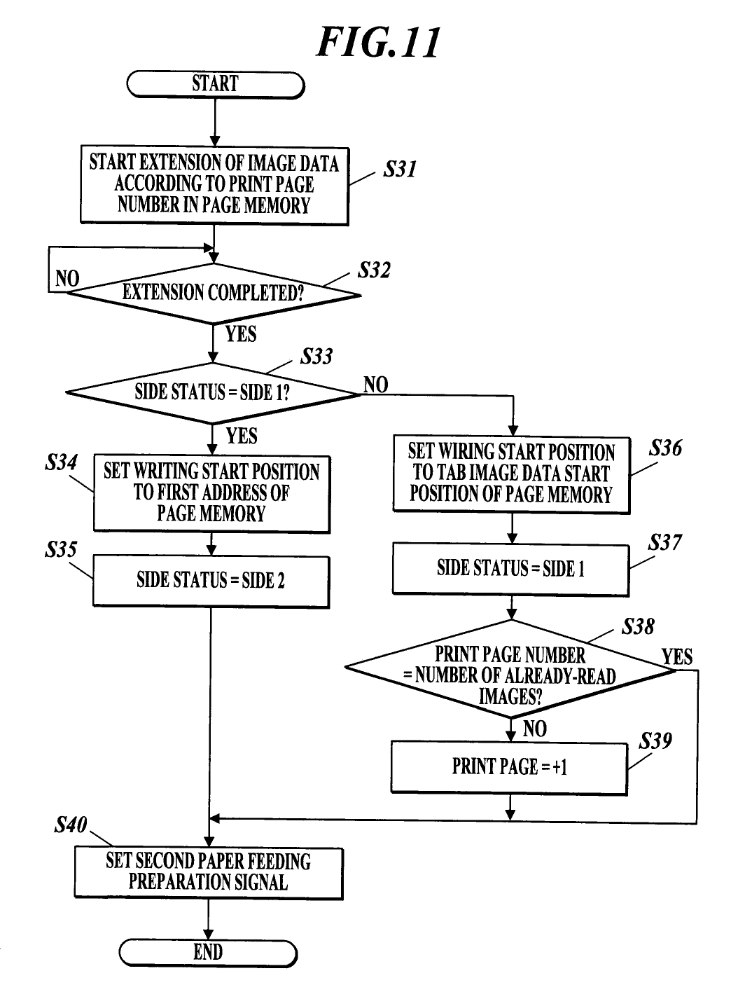

The control section 110 executes the after-mentioned first paper feeding preparation setting process (see FIG. 10) (step S14) and carries out the first paper feeding preparation setting process. Thereafter, the control section 110 executes the after-mentioned print page setting process (see FIG. 11) (step S15) to transmit the copy mode D3 and the like of the job data to the print control section 400 and the after-processing control section 500 and finishes the process.

In FIG. 10, the flowchart of the first paper feeding preparation setting process which is to be executed in step S14 of FIG. 9 is shown. The first paper feeding preparation setting process is a process for setting whether the execution of paper feeding by the paper feeding section 41 is needed or not.

The control section 110 refers to the job data to determine whether the values shown by the paper feeding counter D10 and the number of already read images D9 are equal or not (step S21). When the values shown by the paper feeding counter D10 and the number of already read images D9 are equal (match) (step S21; Yes), the control section 110 finishes the process.

When the values shown by the paper feeding counter D10 and the number of already read images D9 are not equal (do not match) (step S21; No), the control section 110 sets the setting of the paper feeding tray set in the job data as the first paper feeding preparation signal (step S22) and adds 1 to the paper feeding counter D10 (step S23).

The control section 110 determines whether the values shown by the paper feeding counter D10 and the number of already read images D9 are equal or not (step S24). When the values shown by the paper feeding counter D10 and the number of already read images D9 are not equal (do not match) (step S24; No), the control section 110 finishes the process.

When the values shown by the paper feeding counter D10 and the number of already read images D9 are equal (match) (step S24; Yes), the control section 110 sets the final paper information showing that the paper which forms the last document image page is already fed (step S25) and finishes the process.

In FIG. 11, the flowchart of the print page setting process which is to be executed in step S15 of FIG. 9 is shown. The print page setting process is a process for generating and setting the print page data according to the set job data based on the document image data which corresponds to each document page.

The control section 110 refers to the job data to read the document image data stored in the image storage address D12 which corresponds to the identification number of the document page shown by the print page number D8 and starts extension process by the extension IC 180 to start expanding the document image data in the page memory (step S31).

The control section 110 determines whether the extension process of the read document image data is completed or not (step S32). When the extension process is not completed (step S32; No), the process returns to step S32.

When the extension process of the read document image data is completed (step S32; Yes), the control section 110 determines whether the SIDE status D11 is set to side 1 or not (step S33).

When the SIDE status D11 is set to side 1 (step S33; Yes), the control section 110 sets the writing start position to the first address of the document image data expanded in the page memory (step S34) and sets the SIDE status D11 to side 2 (step S35).

When the SIDE status D11 is not set to side 1, that is, when the SIDE status D11 is set to side 2 (step S33; No), the control section 110 divides the document image data expanded in the page memory into text image data and tab image data in sub-scanning direction according to the size of the tab portion and sets the writing start position to the start position of the tab image data (step S36).

For example, when the length of the paper in sub-scanning direction is 9 inches and when the height of the tab portion is 0.5 inches, a position of 216 mm (8.5 inch) is to be set as the writing start position which is to be set in step S36.

After step S36, the control section 110 sets the SIDE status D11 to side 1 (step S37) and determines whether the values shown by the print page number D8 and the number of already read images D9 are equal or not (step S38). When the values shown by the print page number D8 and the number of already read images D9 are equal (match) (step S38; Yes), the control section 110 finishes the process.

When the values shown by the print page number D8 and the number of already read images D9 are not equal (do not match) (step S38; No), the control section 110 adds 1 to the print page number D8 (step S39).

After step S35 or step S39, the control section 110 sets the print page data and the writing start position as the second paper feeding preparation signal (step S40) and finishes the process.

The print page data which is set as the second paper feeding preparation signal in step S40 is the document image data which is expanded in the page memory in step S31, and the writing start position is the writing start position which is set in step S35 or in step S37.

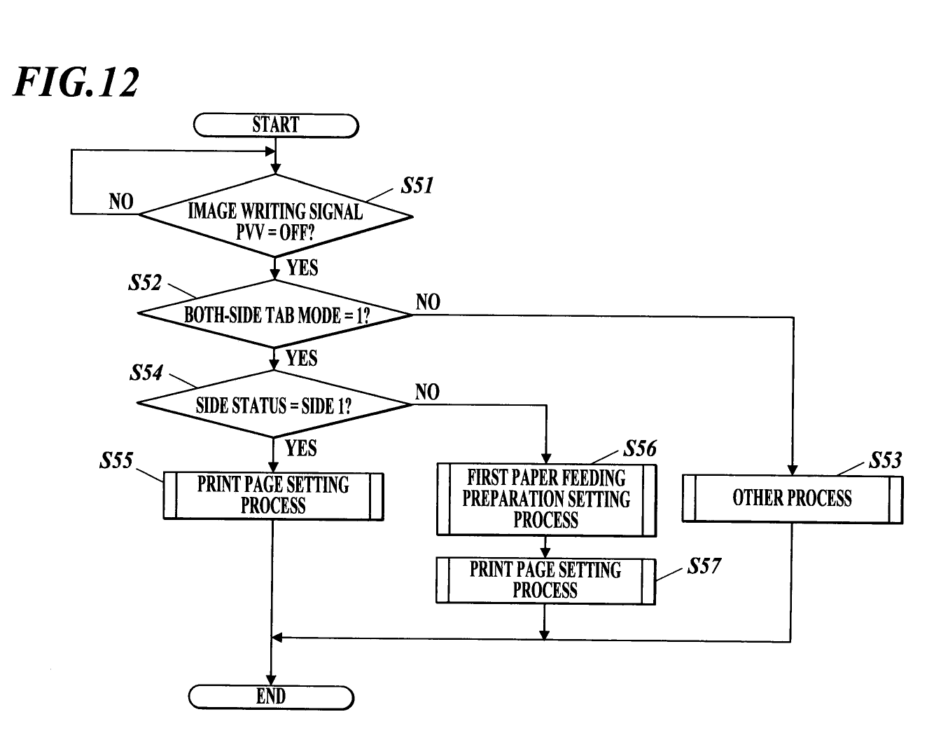

In FIG. 12, the flowchart of the process which is to be executed when the image wiring signal PVV is switched to OFF state from ON state after the image forming process is started is shown.

First, the control section 110 determines whether the image writing signal PVV is switched to OFF state from ON state or not (step S51). When the image writing signal PVV is not switched to OFF state from ON state (step S51; No), the process remains stand-by until the image writing signal PVV is switched (returns to step S51).

When the image writing signal PVV is switched to OFF state from ON state (step S51; Yes), the control section 110 refers to the job data to determine whether the both-side tab mode D7 is set to 1 or not (step S52). When the both-side tab mode D7 is not set to 1 (step S52; No), the control section 110 executes other processes (step S53) and finishes the process.

When the both-side tab mode D7 is set to 1 (step S52; Yes), the control section 110 determines whether the SIDE status D11 is set to side 2 or not (step S54).

When the SIDE status D11 is set to side 2 (step S54; Yes), the control section 110 executes the above mentioned print page setting process (see FIG. 11) (step S55) and finishes the process.

When the SIDE status D11 is not set to side 2, that is, when the SIDE status D11 is set to side 1 (step S54; No), the control section 110 executes the above mentioned first paper feeding preparation setting process (see FIG. 10) (step S56). Then, after the first paper feeding preparation setting process, the control section 110 executes the above mentioned print page setting process (see FIG. 11) (step S57) and finishes the process.

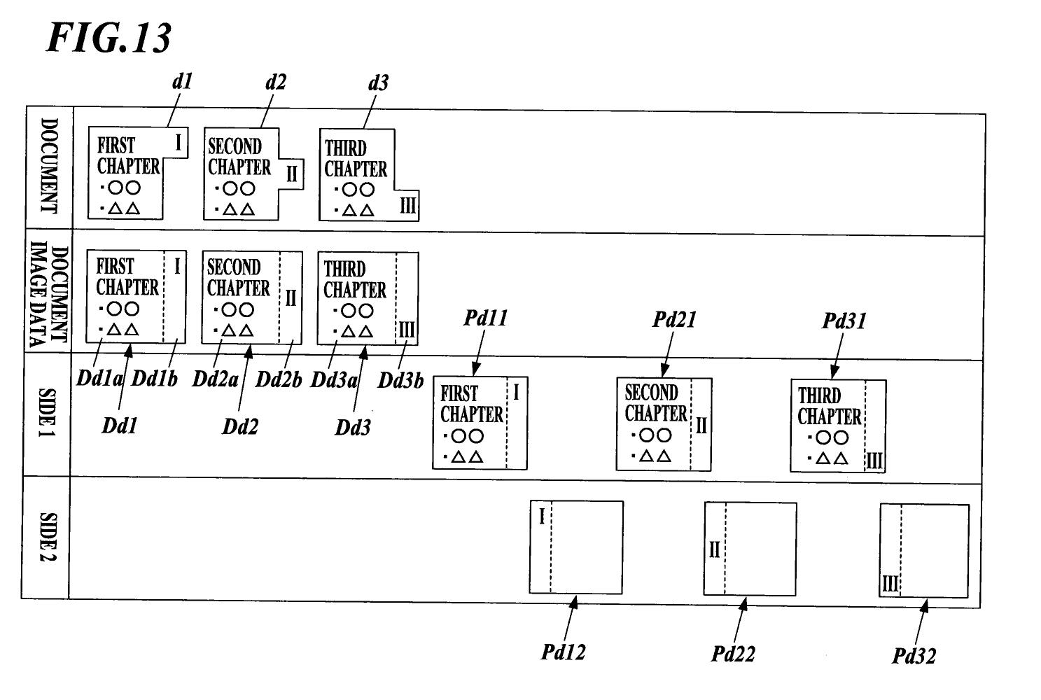

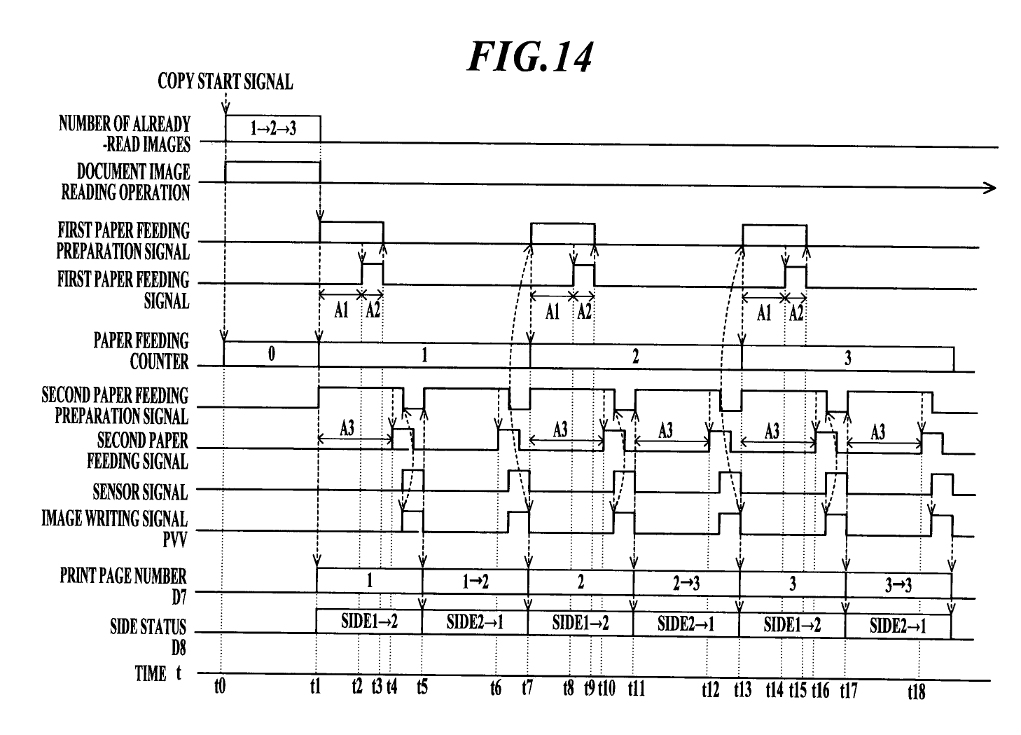

In FIG. 13, a conceptual diagram of the both-side tab paper creating process executed in the embodiment is shown, and in FIG. 14, an example of time chart of operation of the image forming apparatus 1 in which the both-side tab paper creating process of FIG. 13 is realized is shown.

FIGS. 13 and 14 show an example where vertically long tab papers of 8.5 inch×11 inch size is set as the document, where the paper feeding tray in which vertically long papers of 9 inch×11 inch size are stored is set as the paper tray from which the papers are to be fed and where the mode of one-side to both-side print is set as the copy mode in the various types of setting screens shown in FIGS. 2 to 4, and FIGS. 13 and 14 show an example of a process where tab papers are generated by reading three documents.

The documents d1 to d3 shown in FIG. 13 are images of documents placed on the document tray T1 of the image reading section 20. The document image data Dd1 to Dd3 are images of the document image data corresponding to each of the documents d1 to d3 which are read in the image reading section 20. Each of the document image data Dd1 to Dd3 includes the text image data Dd1a, Dd2a and Dd3a, respectively, and the tab image data Dd1b, Dd2b and Dd3b, respectively. The print page data Pd11, Pd21 and Pd31 are conceptual images of the print page data which are to be formed on side 1, that is, on the first side (front side) and the print page data Pd11, Pd21 and Pd31 respectively include text image data and tab image data. Further, the print page data Pd12, Pd22 and Pd32 are conceptual images of the print page data which are to be formed on side 2, that is, on the second side (back side) and the print page data Pd12, Pd22 and Pd32 include at least the tab image data corresponding to the first side.

Next, an example of a time chart of operation of the image forming apparatus 1 shown in FIG. 14 will be described by taking the case of FIG. 13 as an example.

The first paper feeding preparation signal is data including information of the set print page data such as the tray in which the paper to be fed is stored and the like, for example. The first paper feeding preparation signal is outputted to the print control section 400 from the control section 110 and to the after-processing control section 500 via the print control section 400.

The first paper feeding signal is an operation signal for conveying the paper P to the resist roller 42a from the paper feeding tray 41a. The ON state of the first paper feeding signal indicates that the paper is being conveyed. The first paper feeding signal is outputted to the control section 110 from the print control section 400 according to the first paper feeding preparation signal. After the first paper feeding preparation signal is turned on, the first paper feeding signal is turned on after a predetermined time A1 has passed. The predetermined time differs according to the paper feeding tray.

The second paper feeding preparation signal is a signal for indicating whether the writing operation of the print page data can be carried out or not. The ON state of the second paper feeding preparation signal indicates that the writing preparation of the image to be written next is completed, and the OFF state of the second paper feeding preparation signal indicates that the writing is in preparation. The second paper feeding preparation signal is outputted to the print control section 400 from the control section 110.

The second paper feeding signal is an operation signal for conveying the paper to the transfer device 43a from the resist roller 42a. The ON state of the second paper feeding signal indicates that the paper is being conveyed. The second paper feeding signal is outputted to the control section 110 from the print control section 400 according to the second paper feeding preparation signal.

The sensor signal is turned on when the front tip of the paper is detected by a sensor provided on the conveyance path on which the paper is conveyed to the transfer device 43a from the resist roller 42a, and the sensor signal is turned off when the end tip of the paper is detected by the sensor.

When the sensor signal is turned on, the image writing signal PVV is tuned on and the writing is started, and when the writing of the set print page data worth of one page is finished, the image writing signal PVV is turned off. When the image writing signal PVV is turned off, the second paper feeding preparation signal is turned on (however, this process is not carried out at the time of writing of the first page).

First, at time t0, when the copy start signal is inputted from the operation display section 30, the process shown in FIG. 8 is executed. Before the copy start signal is inputted, the various types of setting condition set by the operation display section 30 are stored in the RAM 130 as the job data and the number of already read images D9 of the job data is set to 1 and the paper feeding counter D10 of the job data is set to 0. Further, because the document size is the tab paper of 8.5 inch×11 inch, the paper size is 9 inch×11 inch and the copy mode is the both-side mode of one-side to both-side print, the both-side tab mode D7 is set to 1. After the process is completed, at time t0 to t1, reading of the documents d1 to d3 placed on the document tray T1 is executed.

At time t1, when the reading of the documents d1 to d3 is completed, the processes shown in FIGS. 9 to 11 are executed.

Each of the document image data read by the image reading section 20 is stored in the RAM 130 as job data. Then, the job data is referred and because the both-side tab mode D7 is set to 1, the print page number D8 is set to 1 and the SIDE status D11 is set to side 1.

The paper feeding counter D10 is 0 and this does not match with the value shown by the number of already read images (D9=3). Therefore, the first paper feeding preparation signal is set and turned on based on the setting of the paper feeding tray set in the job data and 1 is added to the paper feeding counter D10. Further, because the paper feeding counter (D10=1) does not match with the number of already read images (D9=3), the final paper information will not be set.

Moreover, the document image data which corresponds to the print page number (D8=1) is expanded in the page memory 172. Because the SIDE status D11 is set to side 1, the writing start position is set to the first address of the document image data expanded in the page memory. Further, the SIDE status D11 is set to side 2 and the print page data Pd11 and the writing start position are set as the second paper feeding preparation signal and the second paper feeding preparation signal is turned on.

At time t2, the predetermined time A1 has passed since time t1 when the first paper feeding preparation signal is tuned on and the first paper feeding signal is turned on, and the paper is conveyed to the resist roller 42a from the paper feeding tray 41a.

At time t3, the predetermined time A2 has passed since time t2 when the first paper feeding signal is turned on and the second paper feeding signal is turned off. When the first paper feeding signal is turned off, the first paper feeding preparation signal is turned off.

At time t4, the predetermined time A3 has passed since time t1 when the second paper feeding preparation signal is turned on and the second paper feeding signal is turned on. When the second paper feeding signal is turned on, the paper is conveyed to the transfer device 43a from the resist roller 42a. Thereafter, when the front tip of the paper is detected by the sensor, the image writing signal PVV is turned on to start the writing and an image is formed on the front side (side 1) of the first paper based on the set print page data Pd11. Further, the second paper feeding preparation signal is turned off when the image writing signal PVV is turned on.

At time t5, the image writing is finished, and the processes shown in FIGS. 10 to 12 are to be executed when the image writing signal PVV is switched to OFF state from ON state.

The job data is referred and because the image writing signal PVV is off and because the both-side tab mode D7=1 and the SIDE status D11=side 2, the document image data which corresponds to the print page number (D8=1) is expanded in the page memory 172. Because the SIDE status D11 is set to side 2, the document image data Dd1 which is expanded in the page memory is divided into the text image data Dd1a and the tab image data Dd1b in sub-scanning direction according to the size of the tab portion. Then, the writing start position is set to the start position of the tab image data Dd1b and the SIDE status D11 is set to side 1. Since the print page number (D8=1) and the number of already read images (D9=3) do not match, 1 is added to the print page number D8 (D8=2). The print page data Pd12 and the writing start position are set as the second paper feeding preparation signal and the second paper feeding preparation signal is turned on.

At time t6, the predetermined time A3 has passed since time t5 when the second paper feeding preparation signal is turned on and the second paper feeding signal is turned on. When the second paper feeding signal is turned on, the paper in which an image is formed on the front side and which is conveyed to the resist roller 42a by the both-side conveyance path 42c is conveyed to the transfer device 43a from the resist roller 42a. Thereafter, when the front tip of the paper is detected by the sensor, the image writing signal PVV is turned on to start the writing and at least the tab image which corresponds to the front side is formed on the back side (side 2) of the first paper based on the set print page data Pd12. The tab image is formed at the tab position, that is, the position plane symmetrical to the position of the tab image formed on the front side. Further, the second paper feeding preparation signal is turned off when the image writing signal PVV is turned on.

At time t7, the image writing is finished, and the processes shown in FIGS. 10 to 12 are to be executed when the image writing signal PVV is switched to OFF state from ON state.

The job data is referred and it is found that the image writing signal PVV is turned off and the both-side tab mode D7=1 and the SIDE status D11=side 1. The paper feeding counter D10 is 1 and this does not match with the value shown by the number of already read images (D9=3). Therefore, the first paper feeding preparation signal is set and turned on based on the setting of the paper feeding tray which is set in the job data, and 1 is added to the paper feeding counter D10. Further, because the paper feeding counter (D10=2) and the number of already read images (D9=3) do not match, the final paper information will not be set.

Moreover, the document image data which corresponds to the print page number D8 is expanded in the page memory 172. Because the SIDE status D11 is set to side 1, the writing start position is set to the first address of the document image data expanded in the page memory, and the SIDE status D11 is set to side 2. Then, the print page data Pd21 and the writing start position are set as the second paper feeding preparation signal and the second paper feeding preparation signal is turned on.

At time t8, the predetermined time A1 has passed since time t7 when the first paper feeding preparation signal is turned on and the first paper feeding signal is turned on, and the paper is conveyed to the resist roller 42a from the paper feeding tray 41a.

At time t9, the predetermined time A2 has passed since time t8 when the first paper feeding signal is turned on and the second paper feeding signal is turned off. When the first paper feeding signal is turned off, the first paper feeding preparation signal is turned off.

At time t10, the predetermined time A3 has passed since time t7 when the second paper feeding preparation signal is turned on and the second paper feeding signal is turned on. When the second paper feeding signal is turned on, the paper is conveyed to the transfer device 43a from the resist roller 42a. Thereafter, when the front tip of the paper is detected by the sensor, the image wiring signal PVV is turned on to start the writing and an image is formed on the front side (side 1) of the second paper based on the set print page data Pd21. Further, the second paper feeding preparation signal is turned off when the image writing signal PVV is turned on.

At time t11, the image writing is finished, and the processes shown in FIGS. 10 to 12 are to be executed when the image writing signal PVV is switched to OFF state from ON state.

The job data is referred and it is found that the image writing signal PVV is off and the both-side tab mode D7=1 and the SIDE status D11=side 2. Therefore, the document image data which corresponds to the print page number (D8=2) is expanded in the page memory 172. Since the SIDE status D11 is set to side 2, the document image data Dd2 expanded in the page memory is divided into the text image data Dd2a and the tab image data Dd2b in sub-scanning direction according to size of the tab portion. Then, the writing start position is set to the start position of the tab image data Dd2b and the SIDE status D11 is set to side 1. Because the print page number (D8=2) and the number of already read images (D9=3) do not match, 1 is added to the print page number D8 (D8=3). The print page data Pd22 and the writing start position are set as the second paper feeding preparation signal and the second paper feeding preparation signal is turned on.

At time t12, the predetermined time A3 has passed since time t11 when the second paper feeding preparation signal is turned on and the second paper feeding signal is turned on. When the second paper feeding signal is turned on, the paper in which an image is formed on the front side and which has been conveyed to the resist roller 42a by the both-side conveyance path 42c is conveyed to the transfer device 43a from the resist roller 42a. Thereafter, when the front tip of the paper is detected by the sensor, the image wiring signal PVV is turned on to start the writing, and at least the tab image which corresponds to the front side is formed on the back side (side 2) of the second paper based on the set print page data Pd22. The tab image is to be formed at the tab position, that is, the position plane symmetrical to the tab image formed on the front side. Further, the second paper feeding preparation signal is turned off when the image wiring signal PVV is turned on.

At time t13, the image writing is finished, and the processes shown in FIGS. 10 to 12 are to be executed when the image writing signal PVV is switched to OFF state from ON state.

The job data is referred and it is found that the image writing signal is off and the both-side tab mode D7=1 and the SIDE status D11=side 1. The paper feeding counter D10 is 2 and this does not match with the value shown by the number of already read images (D9=3). Therefore, the first paper feeding preparation signal is set and turned on based on the setting of the paper feeding tray which is set in the job data, and 1 is added to the paper feeding counter D10. Further, because the paper feeding counter (D10=3) and the number of already read images (D9=3) match, the final paper information will be set.

Moreover, the document image data which corresponds to the print page number D8 is expanded in the page memory 172. Since the SIDE status D11 is set to side 1, the writing start position is set to the first address of the document image data expanded in the page memory and the SIDE status D11 is set to side 2. Then, the print page data Pd31 and the writing start position are set as the second paper feeding preparation signal and the second paper feeding preparation signal is turned on.

At time t14, the predetermined time A1 has passed since time t13 when the first paper feeding preparation signal is tuned on and the first paper feeding signal is turned on, and the paper is conveyed to the resist roller 42a from the paper feeding tray 41a.

At time t15, the predetermined time A2 has passed since time t14 when the first paper feeding signal is turned on and the second paper feeding signal is turned off. When the first paper feeding signal is turned off, the first paper feeding preparation signal is turned off.

At time t16, the predetermined time A3 has passed since time t13 when the second paper feeding preparation signal is turned on and the second paper feeding signal is turned on. When the second paper feeding signal is turned on, the paper is conveyed to the transfer device 43a from the resist roller 42a. Thereafter, when the font tip of the paper is detected by the sensor, the image wiring signal PVV is turned on to start the writing, and an image is formed on the front side (side 1) of the third paper based on the set print page data Pd31. Further, the second paper feeding preparation signal is turned off when the image wiring signal PVV is turned on.

At time t17, the image wiring is finished, and the processes shown in FIGS. 10 to 12 are to be executed when the image writing signal PVV is switched to OFF state from ON state.

The job data is referred and it is found that the image writing signal PVV is off and the both-side tab mode D7=1 and the SIDE status D11=side 2. Therefore, the document image data which corresponds to the print page number (D8=3) is expanded in the page memory 172. Since the SIDE status D11 is set to side 2, the document image data Dd3 expanded in the page memory is divided into the text image data Dd3a and the tab image data Dd3b in sub-scanning direction according to the size of the tab portion. Then, the writing start position is set to the start position of the tab image data Dd3b and the SIDE status D11 is set to side 1. Because the print page number (D8=3) and the number of already read images (D9=3) match, the print page data Pd32 and the writing start position are set as the second paper feeding preparation signal and the second paper feeding preparation signal is turned on.

At time t18, the predetermined time A3 has passed since time t17 when the second paper feeding preparation signal is turned on and the second paper feeding signal is turned on. When the second paper feeding signal is turned on, the paper in which an image is formed on the front side and which has been conveyed to the resist roller 42a by the both-side conveyance path 42c is conveyed to the transfer device 43a from the resist roller 42a. Thereafter, when the front tip of the paper is detected by the sensor, the image writing signal PVV is turned on to start the writing, and at least the tab image which corresponds to the front side is formed on the back side (side 2) of the second paper based on the set print page data Pd32. The tab image is to be formed at the tab position, that is, the position plane symmetrical to the tab image formed on the front side. Further, the second paper feeding preparation signal is turned off when the image writing signal PVV is turned on.

Each of the papers in which images are formed on each side are ejected to the after-processing section 50 by the ejecting section 44. The tab portion is formed in each of the papers ejected to the after-processing section 50 by cutting a portion at a position corresponding to the page number by the cutting unit based on the size of the tab portion, and the papers are ejected to the paper ejection tray T3.

As described above, according to the embodiment, the document image data is divided into the text image data and the tab image data, and the tab image based on the tab image data can be formed on the second side (back side) of the paper at the position plane symmetrical to the tab image formed on the first side, the paper being inversed and conveyed by the inverse conveyance section, after the text image and the tab image are formed on the first side (front side) based on the document image data. Therefore, a tab paper in which the tab image is formed on both sides of the paper can be generated without troubling a user.

Particularly, when the document image data is divided into the text image data and the tab image data according to the size of the tab portion in which the image based on the tab image data it to be formed and when forming the image based on the tab image data on the second side (back side), the tab image to be formed on the first side and the tab image to be formed on the second side can be formed so as to be plane symmetrical to one another by setting the image forming start position of the tab image data which is to be formed on the second side to the image forming start position of the text image data formed on the first side. Further, only the tab image can be formed on the second side.

Moreover, the tab paper having the same form as the document can be created by cutting the paper in which an image based on the tab image data is formed on the second side by the cutting unit 51.

In the above description, an example where the non-volatile memory 120 is used as a computer readable medium of the program according to the present invention is disclosed. However, the present invention is not limited to the example.

As other computer readable medium, the non-volatile memory such as the flash memory and the like, a transportable recording medium such as the CD-ROM and the like can be applied.

Moreover, as for a medium which provides data of the program according to the invention via the communication circuit, the carrier wave can be applied to the present invention.

Further, the present invention is not limited to the above embodiment and can be arbitrarily modified within the scope of the invention.

According to an aspect of the preferred embodiment of the present invention, there is provided an image forming apparatus comprising an image obtaining section to obtain a document image data including a text image data and a tab image data, an image forming section to form an image on a paper having a first side and a second side which is a back side of the first side based on the document image data, an inverse conveyance section to inverse the paper in which the image based on the document image data is formed on the first side by the image forming section and re-convey the paper to the image forming section and a control section to carry out a control to divide the document image data into the text image data and the tab image data, and to form a tab image based on the tab image data on the second side of the paper which is inversed and conveyed by the inverse conveyance section at a position plane symmetrical to the tab image formed on the first side of the paper after a text image and the tab image are formed on the first side of the paper by the image forming section based on the document image data.

According to an aspect of the preferred embodiment of the present invention, there is provided an image forming method comprising image obtaining a document image data including a text image data and a tab image data, image forming an image on a paper having a first side and a second side which is a back side of the first side based on the document image data, inverse conveying the paper in which the image based on the document image data is formed on the first side by the image forming and re-convey the paper to the image forming and controlling to divide the document image data into the text image data and the tab image data, and to form a tab image based on the tab image data on the second side of the paper which is inversed and conveyed by the inverse conveying at a position plane symmetrical to the tab image formed on the first side of the paper after a text image and the tab image are formed on the first side by the image forming based on the document image data.

According to an aspect of the preferred embodiment of the present invention, there is provided a computer readable recording medium storing a program to make a computer realizes a function of a controller to carry out a control to divide a document image data including a text image data and a tab image data into the text image data and the tab image data, and to form a tab image based on the tab image data on a second side of a paper which is inversed and conveyed by an inverse conveyance section for inversing the paper in which an image based on the document image data is formed on a first side and re-conveying to an image forming section after forming a text image and the tab image based on the document image data by the image forming section for forming the image based on the document image data on the first side of the paper having the first side and the second side which is a back side of the first side.

According to the image forming apparatus, the image forming method and the recording medium, the tab paper in which the tab images are formed in both of the first side and the second side can be generated.

Preferably, when forming an image based on the tab image data on the second side, the control section sets an image forming start position of the tab image data to an image forming start position of the text image data formed on the first side.

Further, the tab image to be formed on the first side and the tab image to be formed on the second side can be formed at positions which are plane symmetrical to each other.

Preferably, the control section only forms an image based on the tab image data on the second side.

Further, only tab image can be formed on the second side.

Preferably, the control section divides the document image data into the text image data and the tab image data according to a size of a tab portion in which an image based on the tab image data is to be formed.

Further, the document image data can be divided into the text image data and the tab image data according to the size of the tab portion in which an image based on the tab image data is to be formed.

Preferably, the image forming apparatus further comprises a cutting section to form a tab portion by cutting the paper in which an image based on the tab image data is formed by the image forming section on the second side.

Further, by providing the cutting section for forming a tab portion by cutting the paper in which an image based on the tab image data is formed on the second side, a tab paper having the same form as the document can be created.

The present U.S. patent application claims a priority under the Paris Convention of Japanese paten application No. 2008-127931 filed in Japan Patent Office on May 15, 2008, which shall be a basis of correction of an incorrect translation.

What is claimed is:

1. An image forming apparatus, comprising:
an image obtaining section to obtain a document image data including a text image data and a tab image data;
an image forming section to form an image on a paper having a first side and a second side which is a back side of the first side based on the document image data;
an inverse conveyance section to inverse the paper in which the image based on the document image data is formed on the first side by the image forming section and re-convey the paper to the image forming section; and
a control section to carry out a control to divide the document image data into the text image data and the tab image data, and to form a tab image based on the tab image data on the second side of the paper which is inversed and conveyed by the inverse conveyance section at a position plane symmetrical to the tab image formed on the first side of the paper after a text image and the tab image are formed on the first side of the paper by the image forming section based on the document image data.

2. The image forming apparatus of claim 1, wherein
when forming an image based on the tab image data on the second side, the control section sets an image forming start position of the tab image data to an image forming start position of the text image data formed on the first side.

3. The image forming apparatus of claim 1, wherein
the control section only forms an image based on the tab image data on the second side.

4. The image forming apparatus of claim 1, wherein
the control section divides the document image data into the text image data and the tab image data according to a size of a tab portion in which an image based on the tab image data is to be formed.

5. The image forming apparatus of claim 1, further comprising a cutting section to form a tab portion by cutting the paper in which an image based on the tab image data is formed by the image forming section on the second side.

6. An image forming method, comprising:
image obtaining a document image data including a text image data and a tab image data;
image forming an image on a paper having a first side and a second side which is a back side of the first side based on the document image data;
inverse conveying the paper in which the image based on the document image data is formed on the first side by the image forming and re-convey the paper to the image forming; and
controlling to divide the document image data into the text image data and the tab image data, and to form a tab image based on the tab image data on the second side of the paper which is inversed and conveyed by the inverse conveying at a position plane symmetrical to the tab image formed on the first side of the paper after a text image and the tab image are formed on the first side by the image forming based on the document image data.

7. A computer readable recording medium storing a program to make a computer realizes a function of:
a controller to carry out a control to divide a document image data including a text image data and a tab image data into the text image data and the tab image data, and to form a tab image based on the tab image data on a second side of a paper which is inversed and conveyed by an inverse conveyance section for inversing the paper in which an image based on the document image data is formed on a first side and re-conveying to an image forming section after forming a text image and the tab image based on the document image data by the image forming section for forming the image based on the document image data on the first side of the paper having the first side and the second side which is a back side of the first side.
